(19) United States
(12) Patent Application Publication
(10) Pub. No.: US 2026/0281631 A1
(43) Pub. Date: Sep. 17, 2026

(54) METHOD FOR SUPPRESSING THE MICROPHONE SELF-NOISE OF A HEARING INSTRUMENT AND HEARING INSTRUMENT

(71) Applicant: Sivantos Pte. Ltd., Singapore (SG)

(72) Inventors: Cecil WILSON, Erlangen (DE); Jens HAIN, Erlangen (DE); Nathan Joseph Paul BERWICK, Erlangen (DE); Claudia PISCHEL, Erlangen (DE)

(21) Appl. No.: 19/537,868

(22) Filed: Feb. 12, 2026

(30) Foreign Application Priority Data
Feb. 12, 2025 (DE) 10 2025 105 191.7

(51) Int. Cl. H04R 25/00

(52) U.S. Cl. CPC H04R 25/505; H04R 25/407; H04R 25/604; H04R 2225/41; H04R 2430/01

(57) ABSTRACT

A method for suppressing the self-noise of a microphone arrangement of a hearing instrument includes providing at least one first microphone, and generating a first microphone signal from ambient sound by using the first microphone. A minimum signal level in the first microphone signal is tracked over an operating phase of the hearing instrument, and a first noise floor or noise background is determined on the basis of the minimum signal level. An internal noise threshold of the hearing instrument is determined on the basis of the first noise floor, and the self-noise of the first microphone is suppressed as a function of an activation in which a current level of the first microphone signal or of a signal derived therefrom and the internal noise threshold are included. A hearing instrument is also provided.

### CROSS-REFERENCE TO RELATED APPLICATION

This application claims the priority, under 35 U.S.C. § 119, of German Patent Application DE 10 2025 105 191.7, filed Feb. 12, 2025; the prior application is herewith incorporated by reference in its entirety.

### FIELD AND BACKGROUND OF THE INVENTION

The invention relates to a method for suppressing the self-noise of a microphone arrangement of a hearing instrument which includes at least one first microphone for generating a first microphone signal from a sound signal of the environment. The invention also relates to a hearing instrument.

Hearing aids are typically used to compensate for hearing loss or general hearing impairments. For that purpose, a hearing aid typically includes one or more microphones in order to generate corresponding microphone signals from the ambient sound. The generated microphone signal or signals are processed in a manner dependent on the hearing impairment that is to be compensated for and are thereby amplified, for example, in a frequency band-specific manner and often subjected to noise suppression, which can also be carried out with two or more microphone signals, particularly also using directional microphones. Based on the processed microphone signal(s), an output signal is generated which is then outputted to the hearing aid wearer's ear as an output sound signal via an output transducer, e.g., a loudspeaker or bone conduction receiver.

Signals which are especially quiet are often amplified during signal processing. That can take place on the one hand after the relevant signal components are recognized as a desired signal (e.g., quiet speech); however, background noise can also be amplified, i.e., increased for output, particularly when desired signals are present in an environment in which spatial hearing perception is to be affected as little as possible by directional microphones.

During amplification of quiet signals, however, the self-noise of the microphone or microphones caused by electronic or electro-acoustic processes may also be amplified and thus included in the output sound signal, which can impair the sound quality. If the signal components generated by ambient sound in a microphone signal are stronger than the self-noise of the microphone, they mask the self-noise, which is why it is usually only perceptible at low volume levels in the output sound signal.

Hearing aids therefore often use algorithms to suppress self-noise which usually operate in a manner dependent on measured or estimated sound levels and/or background noise levels. A key problem there is identifying the self-noise to be suppressed or differentiating the self-noise from other low-level signals. That is often achieved by measuring noise characteristics for individual microphone types during factory calibrations, and then those noise characteristics are used for threshold comparisons during the operation of a hearing aid. However, especially with highly sensitive microphones, fluctuations in self-noise can occur due to manufacturing tolerances which are not negligible compared to the noise characteristics.

### SUMMARY OF THE INVENTION

It is accordingly an object of the invention to provide a method for suppressing the self-noise of a microphone arrangement of a hearing instrument and a hearing instrument, which overcome the hereinafore-mentioned disadvantages of the heretofore-known methods and devices of this general type and which suppress the self-noise as precisely as possible and do not impair signal components generated by the microphone arrangement from ambient sound, even at low signal levels.

With the foregoing and other objects in view there is provided, in accordance with the invention, a method for suppressing the self-noise of a microphone arrangement of a hearing instrument, which comprises providing at least one first microphone, wherein a first microphone signal is generated from an ambient sound by the first microphone, a minimum signal level in the first microphone signal is tracked over an operating phase of the hearing instrument, and a first noise floor is determined based on the minimum signal level, an internal noise threshold of the hearing instrument is determined based on the first noise floor, and a self-noise of the first microphone is suppressed as a function of an activation in which a current value of the first microphone signal or a signal derived therefrom and the internal noise threshold are included.

Advantageous and, in some cases, inventive embodiments constitute the subject matter of the following description and subclaims.

In this context, a hearing instrument generally includes any device which, on the one hand, has a microphone arrangement with at least one microphone for generating a microphone signal from ambient sound, and which, on the other hand, is configured to generate a sound signal from an electrical signal—which may in particular also be provided by the microphone signal or by a signal derived therefrom—and to feed it to the ear of a wearer of this device. A hearing instrument can therefore be, in particular, a headphone (e.g., an “earbud”), a headset, a communication device, smart glasses with a speaker, etc. However, a hearing instrument also includes a hearing aid in the narrower sense, i.e., a device intended to compensate for a wearer's hearing impairment in which a microphone signal generated from ambient sound by a microphone is processed into an output signal and, in particular, amplified as a function of the frequency band, and an output sound signal generated from the output signal by a loudspeaker or similar device is suitable, in particular, to compensate for the wearer's hearing impairment, at least partially, in a user-specific manner.

A microphone arrangement of the hearing instrument includes, in particular, the entirety of microphones of the hearing instrument which are disposed in the hearing instrument and generate respective microphone signals from the incident ambient sound, which are then further processed in the hearing instrument.

The term “microphone” generally encompasses any form of electro-acoustic transducer which, by its configuration and construction, is suited and configured to generate an electrical signal from an ambient sound in which voltage and/or current and/or power fluctuations correspond at least approximately to the fluctuations in air pressure caused by the ambient sound. Accordingly, the electrical signal generated by such an electro-acoustic transducer is referred to in a general sense as a microphone signal. In particular, the (first) microphone also includes a microphone in the narrower or actual meaning in which the vibrations of changing air pressure are converted into an electrical voltage signal as a microphone signal by a diaphragm.

An operating phase of the hearing instrument includes, in particular, an extended period of time during which the hearing instrument is operated according to its technical specifications (i.e., using an operating program or the like, but not necessarily worn on the body) and during which the first microphone signal is generated from the ambient sound using the first microphone.

An operating phase can be instantiated in particular by a test operation which takes place during the production of the hearing instrument by the manufacturer before delivery to the customer (or to dealers, etc.), e.g., for quality control, the correct technical functionality of the hearing instrument being checked during the test operation. The aforementioned operating phase can also take place during a fitting process, e.g., at an audiologist or hearing aid acoustician, etc., as an adjustment operation in which, in particular, individual settings of the hearing instrument are preferably customized to a wearer and their specific audiological requirements and are checked accordingly during the adjustment operation.

The operating phase can, in particular, also be normal operation in which the hearing instrument is worn by the wearer in or on the ear as intended and is used in accordance with the technical specifications (i.e., in particular by using one of the operating programs that are provided and set up).

In particular, the operating phase lasts at least 10 seconds, preferably at least one minute, and most preferably at least five minutes, depending on its type. In particular, the operating phase during normal operation can also last at least one hour, preferably at least one day.

Tracking a minimum signal level in the first microphone signal over the operating phase of the hearing instrument means in particular that, at least for the duration of the operating phase, a so-called minimum tracker is applied to the signal level of the first microphone signal, and the minimum signal level reached thus far is recorded and, in particular, stored. Preferably, the data are stored on a nonvolatile memory of the hearing instrument, such as an EEPROM or the like. If the previously stored minimum signal level, i.e., the currently valid minimum value of the signal level, is undershot during the operating phase by a new value of the signal level of the first microphone signal, the new value is stored as the minimum signal level (and the previously valid value is thus overwritten). In particular, a minimum value of the signal level stored in a nonvolatile memory remains there if, in a new operating phase, this stored minimum value is not undershot by a current value of the signal level at any point during the new operating phase.

The minimum signal level is used here in particular as a measure of the self-noise of the first microphone in the first microphone signal. It is assumed here that the minimum signal level over the operating phase corresponds to a signal in which the smallest possible (and preferably negligible to in no way noticeable) signal components of the ambient sound are included. In particular, during an operating phase involving a test or adjustment operation, a sound path for ambient sound to the first microphone can also be physically blocked (e.g., by using a suitable covering or the like).

Accordingly, assuming that the minimum signal level should correspond to a signal without significant components from the ambient sound, a first noise floor for the first microphone or for the first microphone signal is formed from the minimum signal level of the first microphone signal. Preferably, the minimum signal level can be incorporated linearly into the first noise floor, and, in particular, the first noise floor can optionally include a preferably constant or at least temporarily constant normalization factor (i.e., preferably constant on a time scale of at least 10 ms, especially preferably at least 30 ms). The normalization factor in question can thus effect either a static normalization (for example, in the case of a frequency-dependent sensitivity of the first microphone for a frequency-band-wise implementation of the method, or to take into account different sensitivities of other microphones in the hearing instrument) or a dynamic normalization (for example, if a hair or the like temporarily partially covers the first microphone), but on a time scale that is preferably at least one and especially preferably at least two orders of magnitude slower than the verification of the minimum signal level.

Based on the first noise floor determined in this way, the internal noise threshold is now determined, which is used to activate a suppression of the self-noise of the first microphone, i.e., a suppression of the signal components of the first microphone signal that are based on a self-noise of the first microphone. The aforementioned signal components of the first microphone signal, which are based on the self-noise of the first microphone, can be suppressed directly in the first microphone signal itself or in a signal derived from the first microphone signal (i.e., in particular an internal intermediate signal of the signal processing of the hearing instrument).

Advantageously, the first noise floor feeds monotonically into the internal noise threshold, i.e., as the first noise floor decreases—and especially as the minimum signal level for the first microphone signal decreases over the operating phase—the internal noise threshold also decreases, or at least remains unchanged (and does not increase). The underlying idea here is that the internal noise threshold advantageously indicates an “effective” noise floor for further signal processing which is “seen” by the subsequent signal processing and is assumed to exist in the absence of signal components other than the self-noise of the first microphone. This absence of other signal components is modeled by tracking the minimum signal level.

Therefore, if the current value for the signal level of the first microphone signal lies within the range of this “effective” noise floor, there are no other dominant signal components that would clearly mask the self-noise of the first microphone, meaning that the self-noise is perceptibly included in the first microphone signal and the further processing thereof, which is undesirable.

Accordingly, in this case, the suppression of the self-noise of the first microphone is activated, e.g., through a spectral subtraction of the signal components of the self-noise from the first microphone signal and/or by using a Wiener filter, preferably by comparing the internal noise threshold with the current level of the first microphone signal or of a signal derived therefrom, in particular of an intermediate signal of the signal processing of the hearing instrument.

This activation case is thus detected based on the internal noise threshold for which a certain level difference is preferably left over from a calculated noise floor for the comparison with the current level in order to cover, as best as possible, the range in which the current sound level is unable to cover a noise floor given by the self-noise and estimated on the basis of the minimum signal level and possibly other parameters (see below).

The internal noise threshold can, in particular, take into account further parameters of signal processing in the hearing instrument that are not directly attributable to the first microphone signal and that can influence a portion of the self-noise of the first microphone in an output signal generated by the signal processing, i.e., in particular parameters of directional microphones that use the first microphone signal and a second microphone signal generated by a second microphone, and/or parameters of user-specific (and in particular frequency-band-wise) signal amplification, to compensate for a hearing impairment of the wearer.

Preferably, the operating phase is used to track the minimum signal level in the first microphone signal during a fitting process and/or during a test operation in the context of production and/or during normal operation. In particular, an operating phase can last the entire duration of normal operation (in which the hearing instrument is worn by the wearer as intended in or on the ear and used in accordance with the technical specifications, and otherwise remains switched off or is not used in a standby mode), so that the tracking of the minimum signal level is continued without interruption, and the minimum signal level is also continued after breaks in normal operation (e.g., by removing and switching off the device overnight) when normal operation is resumed. However, a reset of a stored value of the minimum signal level can be especially advantageous if the first microphone in the hearing instrument is replaced or otherwise mechanically altered (e.g., during a repair).

It is expedient if the minimum signal level is incorporated linearly into the internal noise threshold over the operating phase. This means in particular that under otherwise constant conditions (given by any further factors and/or further microphone signals), the internal noise threshold Ltot (min1) is a linear function of the minimum signal level min1 of the first microphone signal (particularly with respect to actual levels, i.e., not in dB), meaning that, in particular, Ltot (a·min1)=a·Ltot (min1) holds for any factors a.

Advantageously, when a new minimum value for the signal level of the first microphone signal is reached during the operating phase, the minimum signal level is updated by the new minimum value. This is also known as a minimum tracker. In particular, at the end of the operating phase, the then valid minimum value of the signal level can be retained for the next operating phase (for example through storage in a nonvolatile memory). This takes into account the fact that a spontaneous increase in the sensitivity of the first microphone, in which a possible reset of the valid minimum value would be plausible, is not to be expected in practice.

It is also advantageous if, for signal processing of the first microphone signal during one or the operating phase of the hearing instrument, a first normalization gain that is at least temporarily constant is applied and the internal noise threshold is determined as a function of the first normalization gain. Such an initial normalization gain can be applied particularly when the method is carried out in a frequency-band-wise manner in order to obtain the flattest possible sensitivity or frequency response of the first microphone by using a frequency-band-dependent initial normalization gain and/or to compensate for any differences in the sensitivities of the two microphones if a second microphone is also used in the hearing instrument. Since the first normalization gain is included in the signal processing of the first microphone signal and thus remains inextricably linked to the first microphone signal for subsequent processing steps, any resulting increase or decrease in the self-noise of the first microphone must be taken into account, even if this self-noise is suppressed. In particular, the first normalization gain gn1 can be multiplied as a factor on the minimum signal level min1 of the first microphone signal x1 in order to arrive at the first noise floor nb1, i.e., (possibly up to a time-constant factor) nb1=min1·gn1.

In another advantageous embodiment, the tracking of the minimum signal level in the first microphone signal, the determination of the first noise floor, the determination of the internal noise threshold of the hearing instrument, and the activation of the suppression of the first self-noise of the microphone was carried out independently in a plurality of frequency bands. This means, in particular, that the first microphone signal is divided into the aforementioned plurality of frequency bands, and the aforementioned method steps (tracking the minimum signal level, determining the first noise floor and the internal noise threshold, and activating the suppression of self-noise) are carried out separately from each other in each frequency band, i.e., as independent and autonomous procedures. This takes into account, on the one hand, the fact that in the hearing instrument, the signal processing of the first microphone signal is usually divided into the majority of frequency bands anyway, and any self-noise of the first microphone is included to varying degrees in a processed output signal as a result of frequency-dependent amplification. On the other hand, the self-noise of the first microphone itself can also be frequency-dependent, which is why frequency band-wise suppression is advantageous here (since the suppression is used in a more targeted and need-based manner).

In this case, the first normalization gain is also frequency-dependent (or it may have different values in the individual frequency bands).

Advantageously, a frequency-band-wise value of an audiogram of a wearer of the hearing instrument and/or a total gain of the first microphone signal applied in a respective frequency band is also used for the activation. The total amplification of the first microphone signal applied in the respective frequency band refers in particular to the cumulative amplification of the first microphone signal for the relevant frequency band over the entire signal path from the first microphone to an output transducer (e.g., a loudspeaker) of the hearing instrument.

For example, taking into account the user's audiogram can prevent the application of an algorithm to suppress the self-noise of the first microphone (and possibly other microphones of the hearing instrument) when this would no longer be necessary given the user's hearing ability in a given frequency band. A similar principle applies to considering the overall gain in a frequency band, since noise reduction of the self-noise of the first microphone in frequency bands with very low (or no) overall gain, e.g., in low frequency bands with an open coupling of the hearing instrument, does not achieve any significant effect.

To wit, particularly in the case of quiet signals and thus low signal levels, such an algorithm may be fundamentally prone to impairing the signal quality or the perception of sound, for example by creating artifacts in the first microphone signal (or in a signal derived therefrom) through the algorithm. Thus, the suppression of the self-noise of the first microphone is limited to those cases in which the wearer, due to their hearing ability and/or signal amplification applied to the first microphone signal, would actually be able to perceive the self-noise.

It is also advantageous if a second microphone signal is generated from the ambient sound signal by a second microphone of the hearing instrument, with a minimum signal level in the second microphone signal being tracked over the operating phase of the hearing instrument, and a second noise floor being determined on the basis of this minimum signal level, and the internal noise threshold of the hearing instrument also being determined on the basis of the second noise floor. This means, in particular, that the hearing instrument includes two microphones, with the internal noise threshold—on the basis of which suppression of self-noise of at least the first microphone is activated—being determined based on the minimum signal levels of the two associated microphone signals. The corresponding remarks regarding the first microphone and the associated signal quantities apply analogously to the second microphone, the second microphone signal, the second noise floor, and the minimum signal level.

In particular, the activation of the noise suppression also takes a current value of the second microphone signal or of a signal derived therefrom into account. This includes, in particular, that the internal noise threshold is formed, possibly up to a constant linear factor and/or a constant offset, on the basis of a specific mathematical function F (nb1, nb2) of the first and second noise floor nb1, nb2 (where the minimum signal levels min1, min2 of the first and second microphone signals may also include associated first and second normalization gains), and that a suppression of the self-noise of at least the first microphone is activated by comparing the internal noise threshold with the same mathematical function F (x1 (t), x2 (t)) of the current values of the first and second microphone signals x1 (t), x2 (t).

Especially preferably the internal noise threshold Ltot is formed (particularly in a frequency band-wise manner) as a function of a sum nb1+nb2 of the first and the second noise floor nb1, nb2.

Advantageously, the self-noise of the second microphone—i.e., signal components of the second microphone signal based on the self-noise of the second microphone—are also suppressed as a function of the activation. These signal components can be suppressed directly in the second microphone signal or in a signal derived from the second microphone signal. Preferably, the suppression of self-noise is achieved in an internal intermediate signal of the signal processing of the hearing instrument which is formed using directional microphony of the first microphone signal and of the second microphone signal (or intermediate signals derived from each of them). The self-noise of all microphones in the hearing instrument is thus suppressed in particular.

Advantageously, directional signal processing of the first microphone signal and of the second microphone signal is carried out during the operation of the hearing instrument, with the activation of the suppression of the self-noise of at least the first microphone also taking place as a function of the directional signal processing. This includes, in particular, generating a directional signal as an internal intermediate signal of the hearing instrument based on the first microphone signal and the second microphone signal, from which an output signal of the hearing instrument is derived (possibly through further, especially non-directional, signal processing steps).

In generating the directional signal R(t), signal components of the first microphone signal x1(t) and of the second microphone signal x2(t) are superposed, optionally with a time delay relative to each other, e.g., in the form of

$$R ( t ) ∝ x 1 ( t ) + a \cdot x 2 ( t - τ ) where a ∈ ℝ and τ > 0. \qquad ( i )$$

This superposition enables signal components of the self-noise of the two microphone signals x1, x2 to be attenuated or amplified, particularly as a function of the respective noise power spectrum of the two microphones. Therefore, the directional signal processing of the two microphone signals should be given preferential consideration when activating suppression of the intrinsic self-noise (which is in itself independent of the downstream signal processing of the microphone signals).

It is also advantageous if a comodulation parameter that is dependent on a directivity effect of the directional signal processing is determined and the internal noise threshold is also determined as a function of the comodulation parameter, and/or if a current value of a directional signal resulting from the directional signal processing is included in the activation. This includes in particular that a directional signal is formed like any according to equation (i); here, a directional effect (and thus also the respective angles of maximum and minimum sensitivity) depends in particular on the superposition parameter α and the time delay τ. As a function of this directional effect, and in particular as an indirect function of a and τ, it is now possible to determine the comodulation parameter K (a, τ), which indicates, for example, how much a self-noise is reduced or increased in the directional signal R compared to the original first (or second) microphone signal x1 (or x2) at a given level or noise power. The internal noise threshold is then also determined as a function of this comodulation parameter K. In particular, for the internal noise threshold Ltot, this comodulation parameter K can be multiplied by the sum of the first and second noise floor nb1, nb2, i.e., preferably

$$Ltot ∝ K ( a , τ ) \cdot ( nb 1 + nb 2 ) up to a constant offset . \qquad ( ii )$$

In particular, the internal noise threshold can also be compared with a current value R (t) of the directional signal, and the suppression of the self-noise can be activated as a function of the comparison.

It is also advantageous if the suppression of the self-noise of at least the first microphone is carried out using a Wiener filter and/or spectral subtraction, i.e., in particular, if a Wiener filter and/or spectral subtraction is applied to the first (or second) microphone signal or to a signal derived from the first (and optionally second) microphone signal for the suppression of the signal components of the first microphone based on the self-noise of the first microphone (and preferably also of the signal components of the second microphone based on the self-noise of the second microphone). A Wiener filter can boost or attenuate individual frequency ranges depending on an estimated noise component and an estimated desired signal component.

With the objects of the invention in view, there is concomitantly provided a hearing instrument, comprising at least a first microphone for generating a first microphone signal from ambient sound and a signal processing device which is configured to suppress self-noise of the first microphone by using the method described above. Preferably, the signal processing device for carrying out the method is equipped with at least one corresponding signal processor for performing calculations arising in the method, as well as with a working memory that is addressable by the signal processor, and especially preferably with a further nonvolatile memory for storing program code for algorithms of the method. In particular, the microphone arrangement of the hearing instrument has a second microphone for generating a second microphone signal.

The hearing instrument according to the invention shares some of the advantages of the method according to the invention. The advantages indicated for the method and for its developments may be transferred to the hearing instrument analogously.

Other features which are considered as characteristic for the invention are set forth in the appended claims.

Although the invention is illustrated and described herein as embodied in a method for suppressing the microphone self-noise of a hearing instrument and a hearing instrument, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block diagram of a hearing instrument with suppression of a self-noise of the microphone; and

FIG. 2 is a diagram of an internal noise threshold as a control variable for the suppression of the self-noise according to FIG. 1.

### DETAILED DESCRIPTION OF THE INVENTION

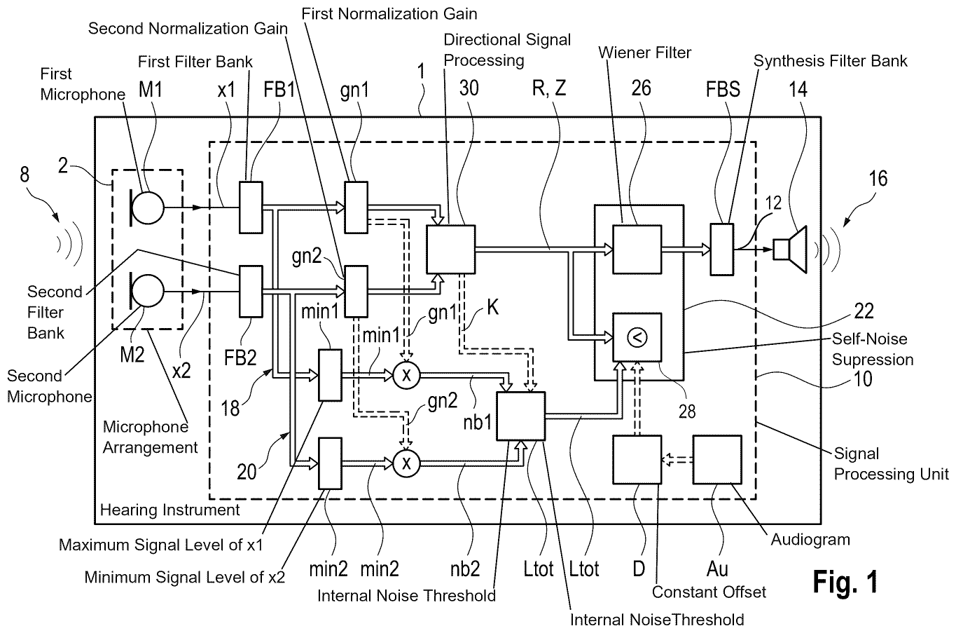

Referring now in detail to the figures of the drawings, in which corresponding parts and variables are each provided with the same reference symbols, and first, particularly, to FIG. 1 thereof, there is seen a block diagram of a hearing instrument 1 with a microphone arrangement 2. The microphone arrangement 2 includes a first microphone M1 and a second microphone M2. The first microphone M1 is configured to generate a first microphone signal x1 from an ambient sound 8. Analogously, the second microphone M2 is configured to generate a second microphone signal x2 from the ambient sound 8. The first microphone signal x1 and the second microphone signal x2 are fed to a signal processing device 10, which has computing and storage measures (not shown in detail) in the form of one or more signal processors, RAM modules, etc., and in which the two microphone signals x1, x2 are processed, preferably taking into account a hearing impairment that is to be compensated for in a wearer of the hearing instrument 1.

In the signal processing unit 10, an output signal 12 is generated from the first microphone signal x1 and the second microphone signal x2 which is converted into an output sound signal 16 by an output transducer 14 of the hearing instrument 1, which in this case is a loudspeaker. The output sound signal 16 is fed to the ear (not shown) of the wearer of the hearing instrument 1. In particular, a bone conduction receiver or any other electro-acoustic transducer can be used as the output transducer which is configured to generate a sound signal from the output signal 12. For this purpose, the first and second microphone signals x1, x2 are each broken down into corresponding frequency bands by a first and a second filter bank FB1, FB2, respectively, so that the subsequent signal processing in the signal processing unit 10 takes place, in particular, frequency band by frequency band. This is indicated in FIG. 1 by the use of double arrows for signals with multiple frequency band channels.

The output signal 12 is generated from an intermediate signal Z generated on the basis of the first and second microphone signals x1, x2, which in this case is given by the directional signal R, as defined, for example, in equation (i). In order to generate the output signal 12 from the directional signal R, additional signal processing steps such as an additional boost or attenuation of individual frequency bands as a function of an audiogram of the wearer may be performed before the output signal 12 is generated at the synthesis filter bank FBS. Before the directional signal R is generated, a frequency-band-dependent first and second normalization gain gn1, gn2 is applied to the individual frequency bands of the first and second microphone signals x1, x2, which in particular compensates for frequency-band differences in the sensitivities of the two microphones M1, M2 and, in particular, can also compensate for a possible frequency dependence of a frequency response of a respective microphone M1, M2. The actual generation of the directional signal R takes place in a directional signal processing 30.

In order to suppress the self-noise of the microphone arrangement 2 —i.e., in order to suppress the signal components in the first (or second) microphone signal x1 (or x2) and thus in the output signal 12 which are based on the self-noise of the first (or second) microphone M1 (or M2)—a self-noise suppression 22 is applied to the directional signal R. In the self-noise suppression 22, which, like the other program steps, can be preferably implemented in the signal processing device 10 as a corresponding software module or also by corresponding hard-wired circuits (for example as an ASIC), the signal components of the first and/or second microphone signal x1, x2, which are based on the self-noise of the microphones M1, M2, are suppressed in the intermediate signal R by using a Wiener filter 26, the application of which to the intermediate signal R is activated as a function of an activation logic 28.

Such a Wiener filter is depicted in U.S. Publication No, 2018/0139 546 A1, for example. For this purpose, for example, a desired signal level and a noise power are determined in the directional signal R in a frequency band-wise manner. Based on the desired signal level and the noise power, a gain factor is determined in the Wiener filter 26 by a filter function having arguments which are the two aforementioned variables on the basis of which, through a corresponding frequency-band-wise multiplication with the intermediate signal Z—i.e., the directional signal R—a self-noise of the first microphone M1 and/or of the second microphone M2 in the preliminary signal can be suppressed.

For the activation of this self-noise suppression 22 in the activation logic 28, a first auxiliary signal path 18 and a second auxiliary signal path 20 are first branched off from the (multi-channel) first microphone signal x1 and from the (multi-channel) second microphone signal x2 in the signal processing unit 10. In the first and second auxiliary signal paths 18, 20, a minimum signal level min1, min2 of the first and second microphone signals x1, x2 (in the respective frequency band) is tracked over an operating phase of the hearing instrument 1. This operating phase can take place on the one hand during the intended normal operation of the hearing instrument 1, i.e., while the hearing instrument 1 is worn by the wearer on his or her ear and used to support a hearing impairment. However, the aforementioned operating phase can also arise due to a test operation at the manufacturer (e.g., after completion of assembly and before delivery to a dealer) or to an adjustment operation at a hearing aid acoustician or the like.

Based on the minimum signal levels min1, min2 of the first and second microphone signals x1, x2, respectively, a first and a second noise floor nb1, nb2 is determined in the respective frequency band, taking into account the first and second normalization gains gn1, gn2. This quantifies the minimum noise floor corrected by the respective normalization gain gn1, gn2, which is “seen” for each microphone M1, M2 by the subsequent signal processing of the signal processing unit 10. In particular, the first and second noise floor nb1 and nb2 can be given by a simple product of the respective minimum signal level min1, min2 with the associated normalization gain gn1, gn2, i.e., approximately nb1=min1·gn1 for each frequency band.

An internal noise threshold Ltot is now determined on the basis of the first and second noise floor nb1, nb1. Furthermore, a comodulation parameter K (a, τ) is determined for this purpose on the basis of the directional signal R (or on the basis of the superposition parameter a and, optionally, the time delay τ in the generation of the directional signal R from the first and second microphone signals x1, x2; see equation (i)). This indicates the extent to which individual components of the self-noise of the first or second microphone M1, M2 are boosted or attenuated in each individual frequency band as a result of the formation of the directional signal R. The internal noise threshold can then be formed, for example, up to a constant offset D, from the sum of the two noise floor values nb1, nb2 multiplied by the comodulation parameter K (see equation (ii)), i.e.,

$$Ltot = K \cdot ( nb 1 + nb 2 ) + D . \qquad ( i )$$

The appropriately selected constant offset D (in dB, preferably with D>0) provides a safety margin for the “actual” value K·(nb1+nb2) of the minimum noise floor of the directional signal R, (which is normally preferably low compared to the occurring levels in order to achieve activation at all when comparing a signal with Ltot). In particular, this offset D can also take into account an audiogram Au of the wearer of the hearing instrument 1 and/or an overall gain applied along the signal processing (not shown) (and, accordingly, also assume a comparatively larger value).

Such activation of the suppression of the self-noise of microphones M1, M2 is preferably carried out in the activation logic 28 by comparing the internal noise threshold Ltot with a current level |R (t)|of the directional signal R. If the current level |R (t)|is greater than Ltot, it is assumed that the signal components based on self-noise of microphones M1, M2 are not perceptibly contained in the directional signal R. If, on the other hand, the current level |R (t)|is less than Ltot, it can be assumed that the corresponding current levels |x1 (t)|, |x2 (t)|of the first and second input signals are sufficiently close to their respective minimum values min1, min2 that self-noise in one of the microphones (or in both) is now audibly included in the directional signal. Accordingly, the activation logic 28 activates the suppression 22 of this self-noise by using the Wiener filter 26.

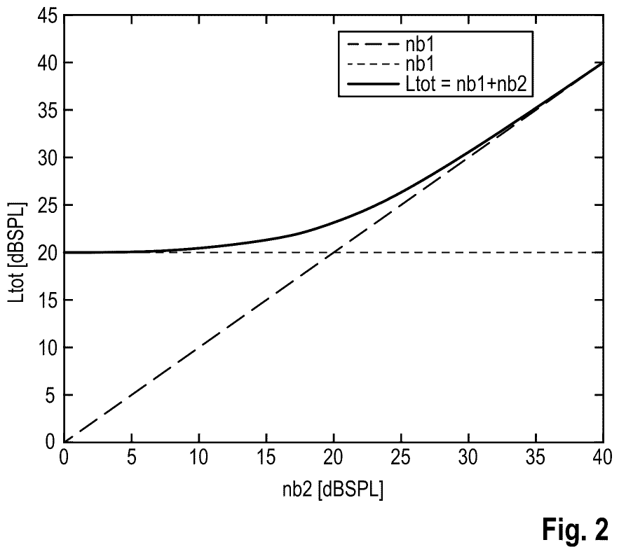

FIG. 2 shows a schematic diagram illustrating the determination of the internal noise threshold Ltot (solid line) according to FIG. 1 as a function of the first and second noise floor nb1, nb2. The first noise floor nb1 (dotted line) is constant at 20 dB, while the second noise floor nb2 (dashed line) varies from 0 dB to 40 dB. The curve of the resulting internal noise threshold Ltot reflects the fact that the two noise floor values nb1 and nb2 are added for this purpose (i.e., Ltot=nb1+nb2, with K=1, see equation (ii)), and the individual quantities are given in dB.

Although the invention has been illustrated and described in detail on the basis of the preferred exemplary embodiment, the invention is not limited by this exemplary embodiment. Other variations can be derived from this by those skilled in the art without departing from the scope of protection of the invention.

The following is a summary list of reference numerals and the corresponding structure used in the above description of the invention:
1 hearing instrument
2 microphone arrangement
8 ambient noise
10 signal processing unit
12 output signal
14 output transducer
16 output sound signal
18 first auxiliary signal path
20 second auxiliary signal path
22 self-noise suppression/suppression of self-noise
26 Wiener filter
28 activation logic
30 directional signal processing
Au audiogram
D offset
FB1/2 first/second filter bank
gn1/2 first/second normalization gain
K comodulation parameter
Ltot internal noise threshold
min1/2 minimum signal level (of the first/second microphone signal)
M1/2 first/second microphone
nb1/2 first/second noise floor
R directional signal
x1/2 first/second microphone signal
Z intermediate signal

1. A method for suppressing self-noise of a microphone arrangement of a hearing instrument, the method comprising:
providing at least one first microphone;
using the at least one first microphone to generate a first microphone signal from an ambient sound;
tracking a minimum signal level in the first microphone signal over an operating phase of the hearing instrument, and determining a first noise floor based on the minimum signal level;
determining an internal noise threshold of the hearing instrument based on the first noise floor; and
suppressing the self-noise of the at least one first microphone as a function of an activation taking into account a current level of the first microphone signal or a signal derived from the current level of the first microphone signal and the internal noise threshold.

2. The method according to claim 1, which further comprises using the operating phase for tracking the minimum signal level in the first microphone signal at least one of:
during a fitting process, or
during a test operation in a context of production, or
during normal operation.

3. The method according to claim 1, which further comprises incorporating the minimum signal level linearly into the internal noise threshold over the operating phase.

4. The method according to claim 1, which further comprises, upon reaching a new minimum value for the signal level of the first microphone signal during the operating phase, updating the minimum signal level by the new minimum value.

5. The method according to claim 1, which further comprises:
for signal processing of the first microphone signal during one operating phase or the operating phase of the hearing instrument, applying a first normalization gain being at least temporarily constant; and
determining the internal noise threshold as a function of the first normalization gain.

6. The method according to claim 1, which further comprises independently carrying out:
the tracking of the minimum signal level in the first microphone signal,
the determination of the first noise floor,
the determination of the internal noise threshold of the hearing instrument, and
the activation of the suppression of the self-noise of the first microphone,
in a plurality of frequency bands.

7. The method according to claim 6, which further comprises additionally using for the activation at least one of:
a frequency band value of an audiogram of a wearer of the hearing instrument, or
a total gain of the first microphone signal applied in a respective frequency band.

8. The method according to claim 1, which further comprises:
generating a second microphone signal from the sound signal of the environment by using a second microphone of the hearing instrument;
tracking a minimum signal level in the second microphone signal over the operating phase of the hearing instrument, and determining a second noise floor based on the minimum signal level in the second microphone signal; and
additionally determining the internal noise threshold of the hearing instrument based on the second noise floor.

9. The method according to claim 8, which further comprises additionally including a current level of the second microphone signal or of a signal derive from the second microphone signal in the activation.

10. The method according to claim 8, which further comprises additionally suppressing the self-noise of the second microphone as a function of the activation.

11. The method according to claim 8, which further comprises:
carrying out directional signal processing of the first microphone signal and of the second microphone signal during the operation of the hearing instrument; and
also carrying out the activation of the suppression of the self-noise of at least the at least one first microphone as a function of the directional signal processing.

12. The method according to claim 11, which further comprises at least one of:
determining a comodulation parameter being dependent on a directivity of the directional signal processing, and also determining the internal noise threshold as a function of the comodulation parameter, or
including in the activation a current value of a directional signal resulting from the directional signal processing.

13. The method according to claim 8, which further comprises using at least one of a Wiener filter or a spectral subtraction to carry out the suppression of the self-noise of at least the at least one first microphone.

14. A hearing instrument, comprising:
at least one first microphone for generating a first microphone signal from an ambient sound; and
a signal processing device configured to suppress self-noise of the at least one first microphone by carrying out the method according to claim 1.
